(19) United States
(12) Patent Application Publication
(10) Pub. No.: US 2005/0134012 A1
(43) Pub. Date: Jun. 23, 2005

(54) Easy handling wheelbarrow

(76) Inventor: Lim Fong Kan, Rawang (MY)

Correspondence Address: BACON & THOMAS, PLLC, 625 SLATERS LANE, FOURTH FLOOR, ALEXANDRIA, VA, 22314, US

(21) Appl. No.: 10/889,087

(22) Filed: Jul. 13, 2004

(30) Foreign Application Priority Data
Dec. 19, 2003 (MY) PI 2003 4902

(51) Int. Cl. B62B 1/00

(52) U.S. Cl. 280/47.34

(57) ABSTRACT

A four-wheeled wheelbarrow with main handle and lever releasable container for easy moving and unloading. The wheelbarrow has a tipping handle rigidly connected to the wheelbarrow container, and a support system for supporting the container. The support system includes two front wheels joined by an axle and independent rear wheels joined by a metal pipe and connected to a pair of container support arms. A tipping lock is mounted on one of the support arms of the support system, for securing the container against tipping during loading activities. The tipping lock is a laterally extending metal bar mounted on the container tipping handle that engages a metal bracket fixed to a support arm.

### FIELD OF THE INVENTION

The present invention relates to wheelbarrows and more particularly to readily maneuverable wheelbarrows with a main handle and lever releasable load container arranged for easy pouring.

### BACKGROUND OF THE INVENTION

Wheelbarrows are well known as a tool for moving heavy loads for a short distance. Typically, a wheelbarrow has a container or pan made from sheet metal supported by a frame including longitudinal beams, a forward wheel and two rear legs. The main handles are typically formed as a pair of parallel members extending to the rear of the container.

The conventional wheelbarrow design suffers from a number of disadvantages. Because the container or pan is mounted on top of the beams, the center of gravity of a loaded wheelbarrow is relatively high and tends to rise as the weight of the load in the pan is increased. Moreover, when the main handles are raised to elevate the rear legs, the center of gravity is raised even higher. This, coupled with the use of a single wheel to support the forward end of the frame, may result in a relatively unstable vehicle, which is difficult to maneuver, and easily overturned. Furthermore, merely moving a wheelbarrow requires that both rear legs be elevated from the ground with the main handles, so a small person may have difficulty in even moving a heavily loaded wheelbarrow.

As such, it is an object of this invention to provide a four-wheeled wheelbarrow with a releasably locked container, which is significantly easier to move and maneuver than is a conventional wheelbarrow.

### SUMMARY OF THE INVENTION

The present invention is a readily maneuverable four-wheeled wheelbarrow with a main handle and a lever releasable container for easy moving and removing loads.

One preferred aspect of the present invention is a wheelbarrow with an assembly of four wheels, and comprising a lever releasable container, a tipping handle rigidly connected to the container, and a support system for supporting the container.

According to a further feature of the invention, a tipping lock actuator associated with a U-shaped metal bracket is mounted on one of the support arms of the wheelbarrow support system for easily selectively securing the container against tipping during loading activities. Furthermore, the container is also equipped with a metal locking bar mounted transversely on the tipping handle for easily fitting into the metal bracket to cooperate with the tipping lock actuator.

In another aspect of the invention, the support system includes two front wheels joined by an axle metal bar, independent rear wheels joined by a metal bar secured with a metal plate, wherein the front and rear wheels are further secured by the support arms.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a rear perspective view of the wheelbarrow according to present invention with the container in its lowered position;

FIG.2 is a rear perspective view of the wheelbarrow when the tipping lock has been released with the container tipped slightly;

FIG.3 is a rear view of the wheelbarrow when the tipping lock has been released and the container has been tipped forwardly;

FIG.4 is an enlarged detail view of the lever-released tipping lock of the wheelbarrow in a secured or locked position in accordance with one aspect of the present invention;

FIG.5 is the enlarged view of the tipping lock in a released position with the container freed for tipping; and

FIG.6 is a detail of the support system of the wheelbarrow in accordance with one aspect of the present invention.

### DETAILED DESCRIPTION OF THE PREFERRED EMBODIMENT

The present invention relates to a readily maneuverable wheelbarrow with a handle arrangement and a tipping lock secured container for easy lifting and pouring loads.

The principal of operation of the wheelbarrow according to the present invention will be better understood with reference to the drawings and accompanying description.

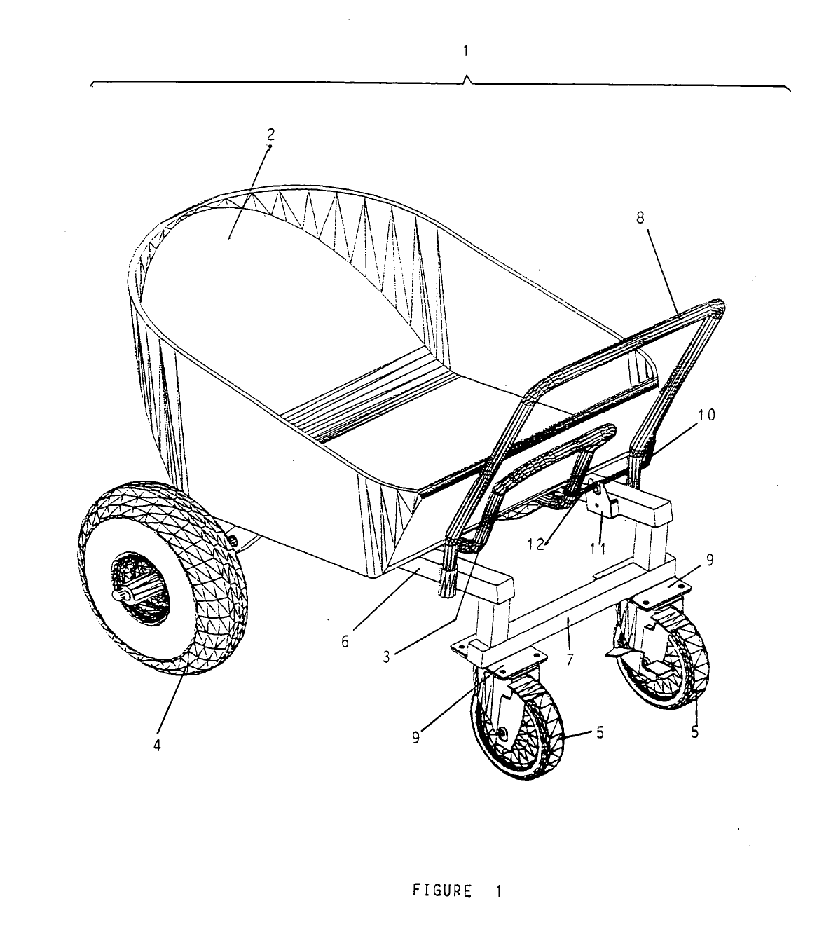

Referring now to drawings, FIG. 1 show a wheelbarrow, generally designated (1), constructed and operative according to the teachings of the present invention. Generally speaking, wheelbarrow (1) has a container (2) having at least one slanted front end shape with a U-shaped tipping handle (3) rigidly connected thereto, and a support system including at least one front wheel assembly (4), at least one independent rear wheel (5) connected by supported metal pipe (7) to at least one support arm (6) that supports the container (2) and a U-shaped main handle (8) directly mounted on the support arm (6) for moving the wheelbarrow.

It will be readily apparent that the main handle (8) offers a considerable improvement in functionality over conventional wheelbarrow handle designs. With reference to FIGS. 1, 2 and 3, it will be noted that a human hand can easily grasp a horizontal or transverse part of the handle (8) and push the wheelbarrow forward or backward smoothly, thereby minimizing arm strain.

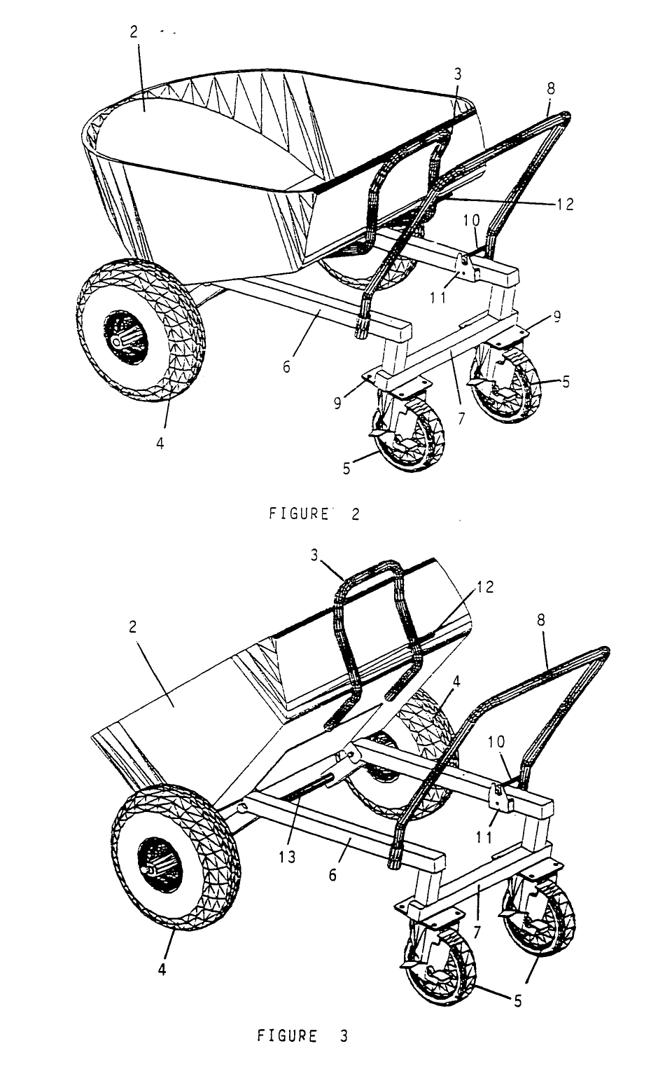

An additional preferred feature of wheelbarrow (1) is the provision of container (2) with a U-shaped tipping handle (3). The container (2) with a sloped end shape can be easily lifted up by the curved tipping handle (3) and the load may be tipped out easily as shown in FIGS. 2 and 3. As such, a small person can easily operate the wheelbarrow (1) with minimum energy. Additionally, the described tipping handle configuration facilitates tipping of the wheelbarrow (1). Unlike the conventional parallel-bar type handles, no change of grip is normally required while raising the container (2) from its rest position to a tipped state.

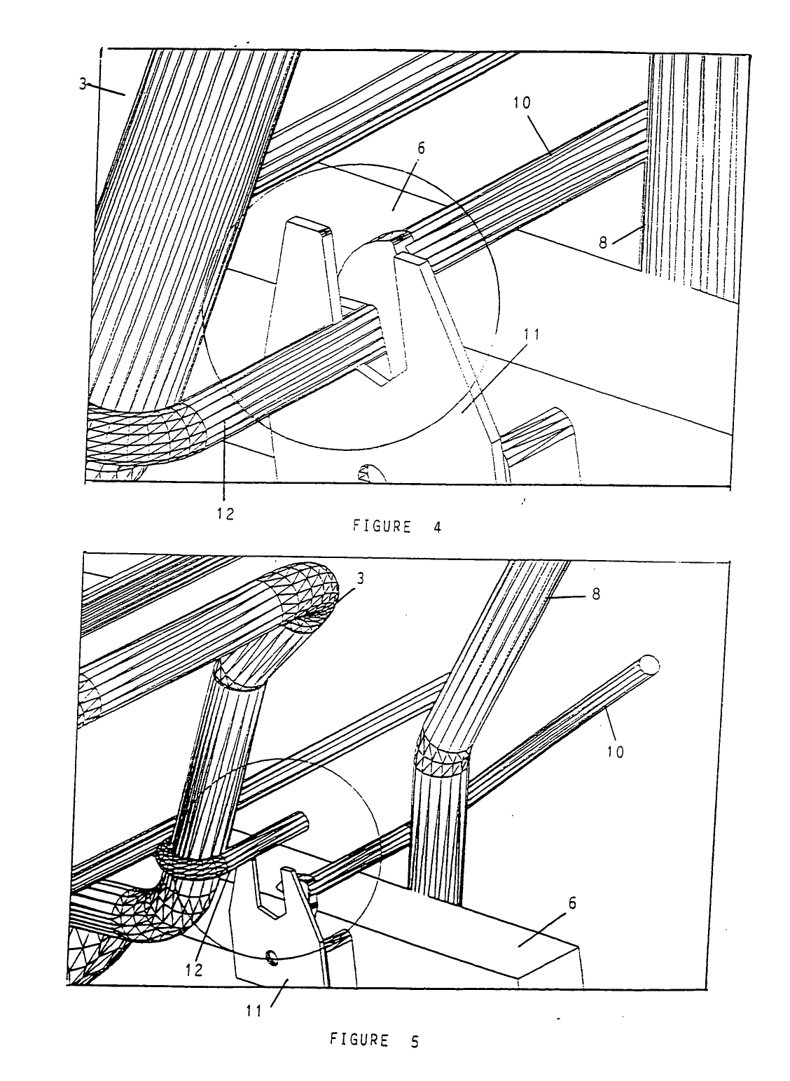

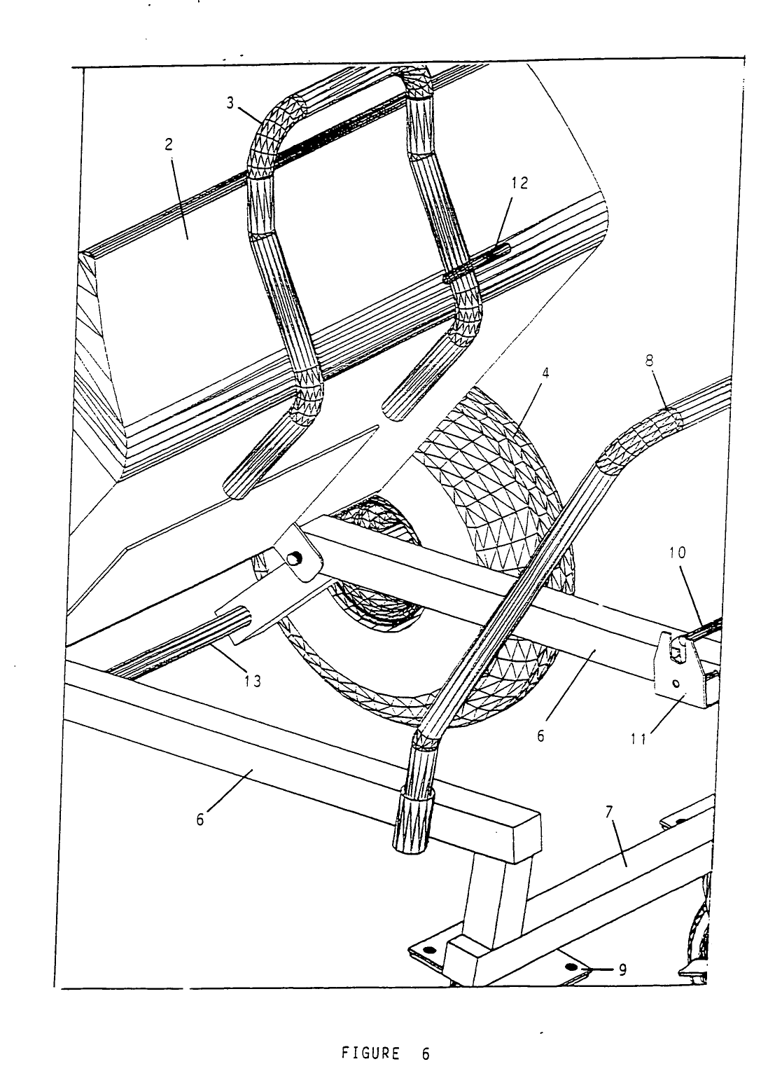

The securing system of the container (2) on the wheelbarrow (1) includes a releasable tipping lock system, which can be seen in FIGS. 4 and 5. The special lock system includes at least one upwardly open U-shaped metal bracket (11) attached to a wheelbarrow support arm (6); at lease one lock actuator handle (10) with a hook at one end fix on the wheelbarrow main handle (8); and at least one transverse locking metal bar (12) horizontally or laterally extending from the tipping handle (3) to which it is attached. The forward end of the container is connected to the forward end areas of the supporting arms (6) with metal brackets that serve as pivot points for the container relative to the support arms allow the said releasable container to tip into an unloading position.

For locking the tipping lock, the metal bar (12) will be located in the U-shaped metal bracket (11). The bar is further secured by the hook of the locking actuator handle (10) which can be seen in detail in FIG. 4. This ensures that the wheelbarrow container (2) in a rest position cannot be tipped forward. When the lever actuator (10) is pivoted down as in FIG. 5, the hook on the end of actuator handle (10) will be freed and thus the locking metal bar (12) is freed from the U-shaped metal bracket (11). Then the tipping 2) can be easily tipped up by the container handle (3) to a tipped state.

Turning now to the features of wheelbarrow (1) support system in more detail, preferably two front wheels (4) are joined by an axle metal bar shaft (13). This will prevent the wheelbarrow (1) from losing balance and enables it to be moved easily as the container (2) is loaded. The independent rear wheels (5) are connected to the wheelbarrow (1) support system through a metal pipe (7) connected to the supported arm (6). This enables the rear wheels (5) to move independently and rotate or swivel 360 degrees freely without interrupting the front wheel (4) movement. As such, this feature provides the wheelbarrow (1) with freedom of moving easily, minimizes the energy used, while providing great maneuverability.

Preferably, the independent rear wheels (5) are connected to each other by a metal pipe (7) through a metal plate (9). The front wheels (4) and the rear wheels (5) are joined by supported arms (6) on both sides. As seen in FIGS. 1, 2 and 3, the front wheels (4) are always larger than the rear wheels (5). This is to provide a better balancing to the wheelbarrow (1).

It is to be understood that the present invention may be embodied in other specific forms and is not limited to the sole embodiment described above. However, modifications and equivalents of the disclosed concepts such as those which readily occur to one skilled in the art are intended to be included within the scope of the claims which are appended thereto.

1-4. (canceled)

5. A wheelbarrow comprising:
a load container having a front and rear area;
a tipping handle connected to the rear area of the load container to enable tilting of the load container about a transverse axis located towards the front of the container;
a support and wheel arrangement supporting the container for movement across a surface, said support and wheel arrangement comprising:
a frame extending underneath the container, said frame including at least one longitudinally extending support arm disposed under the container, said container pivotally supported on the support arm towards a front end of the support arm;
a pair of front wheels connected by an axle, said axle connected to a front end area of the at least one support arm;
at least one rear wheel connected to a rearward end area of the at least one support arm;
a main handle having a transverse handle portion enabling manipulation of the wheelbarrow secured to said at least one support arm at a rear area of the at least one support arm;
a tipping lock associated with the container, said lock including a locking element selectively fixable relative to the frame for preventing unintentional tipping of the container when said locking element is fixed relative to the frame;
a tipping lock actuator enabling selective fixation of the locking element relative to the frame.

6. The wheelbarrow according to claim 5, wherein said tipping lock comprises an upwardly open u-shaped socket secured to the at least one support arm said locking element comprising: a transversely extending rod secured to the tipping handle and located so as to enter the socket when said container is in an untipped position; a locking hook movable relative to the socket and arranged to selectively close the socket from above and to secure the rod in the socket when in a locking position; and an actuator handle for manipulating the locking hook between locked and unlocked positions.

7. The wheelbarrow according to claim 5, said at least one support arm comprising a pair of longitudinally extending support arms; a transverse member connecting together the support arms at their rear areas, said at least one rear wheel connected to said transverse member.

8. The wheelbarrow according to claim 7, said tipping and main handles are generally U-shaped and connected at the open ends of the U-shapes to the container and the support arms, respectively, and include transversely extending portions.

9. The wheelbarrow according to claim 5, said at least one rear wheel mounted for pivotal rotation about a swivel axis.

10. The wheelbarrow according to claim 9, wherein said front wheels are larger in diameter than said at least one rear wheel.

11. The wheelbarrow according to claim 6, said locking hook pivotaly mounted on said main handle.

12. The wheelbarrow according to claim 5, said at least one support arm comprising a pair of laterally spaced, longitudinally extending support arms; said axle connecting said front wheels connected to forward areas of said support arms.

13. The wheelbarrow according to claim 12, said at least one rear wheel comprising a pair of rear wheels connected to rearward areas of said support arms.
